(19) United States
(12) Patent Application Publication
(10) Pub. No.: US 2005/0179172 A1
(43) Pub. Date: Aug. 18, 2005

(54) Method for preparing porous bioceramic bone substitute materials

(75) Inventors: Feng-Huei Lin, Taipei City (TW); Chun-Jen Liao, Taipei City (TW)

Correspondence Address: BACON & THOMAS, PLLC, 625 SLATERS LANE, FOURTH FLOOR, ALEXANDRIA, VA, 22314, US

(73) Assignee: Purzer Pharmaceutical Co., Ltd., Taipei City (TW)

(21) Appl. No.: 11/101,574

(22) Filed: Apr. 8, 2005

(30) Foreign Application Priority Data
Jan. 27, 2004 (TW) 093101704

(51) Int. Cl. C04B 33/32

(52) U.S. Cl. 264/643

(57) ABSTRACT

A method for preparing porous bioceramic bone substitute materials is disclosed, which includes the following steps: (a) providing a cancellous bone of animals, (b) removing organic substances in the cancellous bone by thermal processing to obtain de-organic cancellous bone, (c) soaking the de-organic cancellous bone in a solution of phosphate salts, and (d) obtaining the porous bioceramic materials by sintering between 600 to 900° C. The porous bioceramic bone substitute materials of the present invention are suitable for use as filling materials of bone defect.

### BACKGROUND OF THE INVENTION

1. Field of the Invention

The present invention relates to a method for preparing ceramic materials, in particular to a method for preparing porous ceramic materials that can be used as bioceramic bone substitute materials.

2. Description of the Related Prior Art

Currently, the greatest difficultly encountered with the xenotransplant of bone is the immune rejection by the biological body itself. In the past, various researchers and scholars have attempted to overcome immune rejection of the bone through various techniques such as freezing, boiling, and immersing in chemicals, however the attempts still failed to effectively prevent immune rejection. In 1988, Mittelmeier and several of his colleagues successfully removed the major reason of immune rejection—organic substances of an ox bone by heating the bone to a high temperature. Through the aforementioned technique what is left are the inorganic composites, which have high bio affinity.

Ca₁₀(PO₄)₆ (OH)₂ (hydroxyapatite, HAP) is the main inorganic substance of a bone; when the organic substances are removed from the bone, the residual minerals can be regarded as a ‘green’ when compressing the powdery minerals together; as heat is continuously applied, a strong ceramic structure can be obtained. The bone is obtained from the cancellous bone of an ox, which naturally consists of porous matter of up to 70% or more by volume. Hence, by taking advantage of this characteristic, HAP dominant naturally porous ceramic material can be obtained. Presently, the aforementioned material is already widely used as a substitute material for bone defects in orthopedics clinical operations.

HAP is the principal inorganic substance of an oxp3 s cancellous bone, and is also analogous to the bone composition of a human being, as when transplanted to a human body great bio affinity can be exhibited. Because of the composition likeness of bone between the two species, the transplanted environment of a body tends to be in a stable equilibrium condition. The transplanted material can contact bone structure to form a linking layer, but the transplanted material will not degrade in the biological body. Consequently, as the new bone tissue of the body assists the recovery of the defective bone, the material is still attached to the defective bone and interferes the substitution by new born tissue. According to the trend of the present biomedical materials development, the present technology cannot provide a perfectly imitative or replacement material for the functional organs of the biological body, but the circumstance of leaving the transplanted material inside the body as a foreign substance is also not a desirable option. As a result, innovations towards a biodegradable substitute material are the main stream of the present biomedical-material development. In recent years, researchers have experimented with the highly dissolvable tricalcium phosphates (Ca₃(PO₄)₂, TCP), where it is mixed with HAP to form an HAP/TCP ceramic material. On the other hand, another option is to directly work with biomedical materials that are highly dissolvable such as calcium carbonate, calcium sulfate, dicalcium phosphates (Ca₂P₂O₇; DCP) etc. Of those materials, DCP is highly focused on, and according to the related animal experiment results, DCP demonstrates an excellent adaptation toward biological bodies. Furthermore, DCP can gradually degenerate and be replaced by bone tissues inside the human body. Moreover, with the development of new osteoporosis drugs in recent years, the P₂O₇⁴⁻ ions of DCP are also valued. The P₂O₇⁴⁻ ions have the characteristic of adsorption onto the surfaces of a bone to form a layer of P₂O₇⁴⁻ ions, and this layer of P₂O₇⁴⁻ ions is proven to resist the adsorption of osteoclasts, thereby reducing the amount of ossein drains due to the osteoclasts. As a result in the perspective of biomedical material or osteoporosis medicine, the method for preparing a bio- absorbable DCP material is of particular interest to the relevant technicians.

The ox bone is processed by heating wherein the organic substances are removed accordingly, and the inner structure is transformed to a powdery structure that is made into fine pellets afterwards. At this point liquid additives can be added and absorbed by the inner structure of bone which is then oven dried to achieve an evenly composition of original ox bone. According to the previous experiment results, adding ammonium pyrophosphate ((NH₄)₂HPO₄, AP) to an ox bone under elevated temperature may transform the HAP of the ox bone to a TCP. The presence of this transformation is due to the dehydration of the HPO₄²⁻ of AP at high temperature, which produces a P₂O₇⁴⁻ ion; by reacting the P₂O₇⁴⁻ ion with OH⁻ ion of HAP in the presence of high temperature a PO₄³⁻ ion is further formed; through the reaction mechanisms HAP is transformed to TCP. Immersing in various concentrations of AP solvent also results in different amounts of AP that the bone possesses, likewise different ratios of TCP/HAP ceramic material can be obtained under high temperature. Applying the same principle, if the amount of AP added is increased the amount of P₂O₇⁴⁻ ions produced is also increased, thereby enabling the inorganic bone to transform from HAP to TCP and even further to DCP. The present invention is to immerse an ox bone with organic substances removed and not yet be sintered under various concentrations of AP aqueous solution and subsequently dry and sintered the bone. With the changes in concentrations of the AP aqueous solution, biomedical ceramic materials with different concentrations of TCP/DCP or DCP crystallization can be obtained.

Therefore, it is desirable to provide an improved method for preparing porous bioceramic materials for substitution in a defective bone to mitigate and/or obviate the aforementioned problems.

### SUMMARY OF THE INVENTION

An object of the present invention is to provide a method for preparing porous bioceramic bone substitute materials, which can be used for producing a bone substitute material.

Another object of the present invention is to provide a method for preparing porous bioceramic bone substitute materials, from where various crystalline phase compositions or crystallization structures of the porous bioceramic bone substitute materials can be obtained.

Yet another object of the present invention is to provide a method for preparing porous bioceramic bone substitute materials, from where the ratio of the obtained crystalline phase compositions of the porous bioceramic bone substitute materials can be controlled.

The method for preparing porous bioceramic bone substitute materials of the present invention comprises (a) providing a cancellous bone of an animal; (b) heating the cancellous bone to remove the organic substances within; (c) immersing the organic free cancellous bone in a phosphate aqueous solution; and ( d ) drying and sintering the cancellous bone at a temperature of 600˜900° C., thereby obtaining a porous bioceramic bone substitute with different crystalline phase compositions.

According to the method of the present invention, a β-TCP/DCP or DCP porous ceramic material is produced, where it is preferred to transplant to an HAP or β-TCP bone structure environment to demonstrate a better clinical result. Furthermore, according to the method of preparing the present invention, sintering under the addition of various concentrations of phosphate or various temperatures will result in different ratios of β-TCP/DCP or DCP ceramic material.

Other objects, advantages, and novel features of the invention will become more apparent from the following detailed description when taken in conjunction with the accompanying drawings.

### BRIEF DESCRIPTION OF THE DRAWINGS

FIG. 1 shows readings for crystalline phase changes of ox cancellous bone under various concentrations of being respectively immersed in AP aqueous solutions as examples 1 to 6;

FIG. 2 is the observed result of ox cancellous bone from SEM after immersing in 3.5 mole/L of AP aqueous solution and sintering at 900° C. in example 1; and

FIG. 3 shows readings for crystalline phase changes of ox cancellous bone after sintering at various temperatures, examples 7-12.

### DETAILED DESCRIPTION OF THE PREFERRED EMBODIMENT

The method for preparing porous bioceramic bone substitute materials of the present invention utilizes animal cancellous bone as an ingredient. Organic substances of the cancellous bone are removed by heating, and then the bone is immersed in a phosphate aqueous solution. The bone is then dried and subsequently sintered at a temperature of 600˜900° C. and a porous bioceramic bone substitute material consisting of β-TCP/DCP or DCP is obtained.

The method for preparing the present invention, the species from which the cancellous bone is obtained can be any. Cancellous bones of mammals are more preferable, for example ox, horse, pig, rabbit and mouse, other species such as chicken, duck, swan, fish and etc. The form and size are also not critical; generally, cancellous bones of pig or ox are divided into dimensions of 0.1-10 cubic centimeters.

The animal cancellous bone of the present invention is a processed material, in order to prevent cracking of the cancellous bone from heating during processing, thus, the organic substances of the animal cancellous bone must be completely removed. There are abundant techniques relating to the removal of organic substances from animal bones. The techniques are familiar to any skilled personnel, and there are no specific restrictions toward any techniques regarding to the present invention as long as the organic substances are removed from the bone. Examples of the present invention employ the heating technique, where the ox bone is boiled in water for 6 hours to remove the greases and fats. Immediately afterwards, alcohol is applied to the oil free bone for dehydration gradually, and then the dehydrated bone is oven dried for 3 days at 70° C. The processed cancellous bone is then placed and heated in a platinum crucible at an elevated temperature to further remove any organic substances. The temperature is increased at a rate of 5° C./min, until 800° C. is reached, whereafter the temperature remains constant for 6 hours to assure all the organic substances of the cancellous bone are removed.

The method of preparing the present invention comprises use of a phosphate aqueous solution, which can be phosphate salt solution such as an AP aqueous solution, alkaline metal phosphate aqueous solution, and an alkaline earth metal phosphate salt solution. Wherein, preferably the concentration of the AP aqueous solution is greater than 1 mole/liter.

The organic free and not yet sintered animal cancellous bone is immersed in various concentrations of phosphate aqueous solution. Subsequently the cancellous bone is dried and sinter at a temperature of 600˜900° C.; with control various types of porous bioceramic bone substitute materials can be obtained.

Regarding the porous bioceramic bone substitute material obtained, and the determination of various crystalline phase structures thereof, methods such as x-ray diffraction (XRD), Fourier transform infrared (FTIR), and scanning electron microscope (SEM) are used for determining the compositions and ratios. The aforesaid skills are familiar to any skilled personnel, and will not be explained here.

More detailed examples are used to illustrate the present invention, and these examples are used to explain the present invention. The examples below, which are given simply by way of illustration, must not be taken to limit the scope of the invention.

### EXAMPLE 1

A method for preparing porous bioceramic bone substitute materials comprises obtaining a cancellous bone that is selected from the knee joint of an ox femur. A power saw is used to divide the bone into parts of 1 cubic centimeter, after which the bones are boiled in water for 6 hours to remove the greases and fats. Alcohol is then immediately applied to the boiled bone parts to carry out dehydration, thereby preventing the bones from cracking during subsequent processing under extreme heat; the bones are then dried in a 70° C. oven for 3 days. The processed ox bones are placed and heated inside a platinum crucible for the purpose of removing the organic substances. The heating rate is set at 5° C./min until 800° C. is reached, and this temperature is kept constant for 6 hours to assure all organic substances are completely remove from the ox bones. Afterwards, the organic free yet not sintered ox bones are sampled for the experiments below.

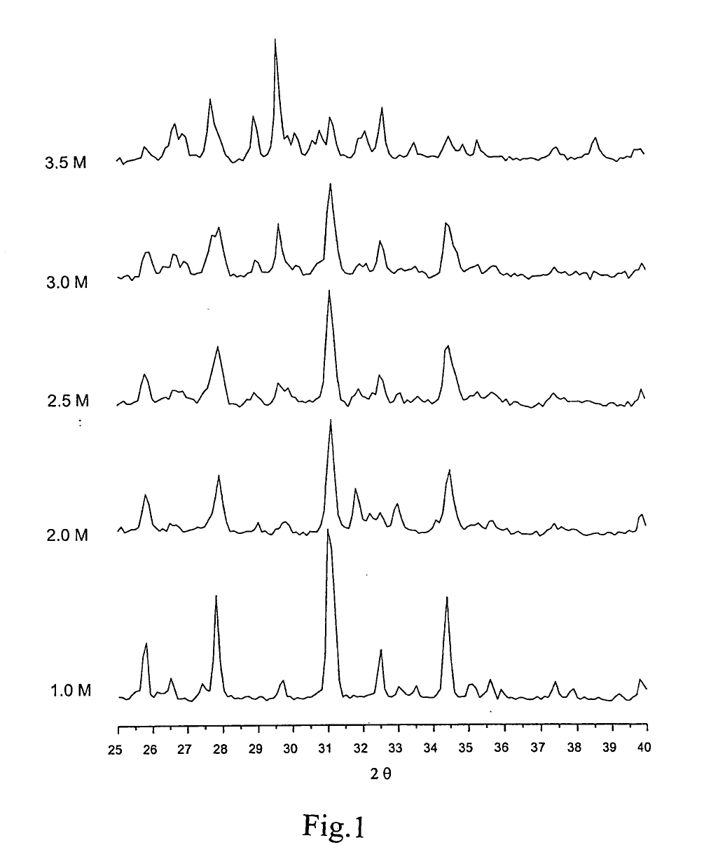

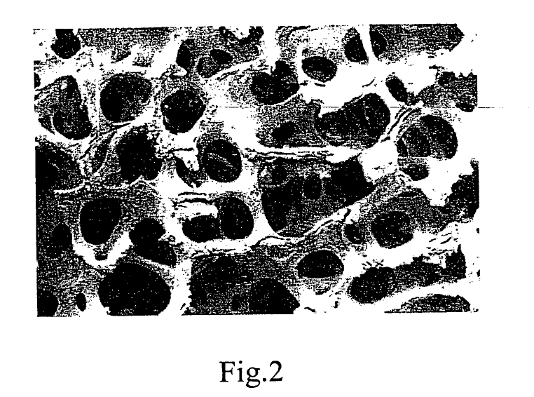

Samples of the organic free yet not sintered ox bone are immersed in an AP aqueous solution with a concentration of 3.5 mole/L. In the course of about 24 hours, the immersed ox bones are removed and the excess AP aqueous solution remaining on the surfaces is absorbed with a piece of filter paper. In addition, the moistures of the bones are removed by placing them in an oven at a temperature of 70° C. Next, the samples are placed inside a platinum crucible with a top, which is then heated up by an SiC heating body. The resultant samples of various temperatures are analyzed by x-ray diffraction (XRD) for crystalline phase changes, and the results are shown in FIG. 1. The results of SEM analysis are shown in FIG. 2, which indicate that after immersing with AP aqueous solution and sintering at 900° C., phase transition takes place but the porous structure of the ox cancellous bone remains.

### EXAMPLES 2-6

The same procedures as in example 1 are repeated, but this time the concentration of AP aqueous solution is changed, instead, 5 AP aqueous solutions are prepared, wherein each respectively has a concentration of 1.0, 1.5, 2.0, 2.5, and 3.0 mole/L. The results of crystalline phase changes are determined by XRD analysis and are as shown in FIG. 1.

As observed from FIG. 1, the HAP diffraction peaks of the ox bone immersed in a 1.0M AP aqueous solution have fully disappeared, and are instead transformed to β-TCP. By increasing the amount of AP aqueous solution, gradually the strength of β-TCP diffraction peaks diminish; when the concentration of AP aqueous solution is at 3.5M, almost all of the β-TCP of the ox bone are replaced by DCP, resulting in DCP as the sole composite. Examples 7˜12

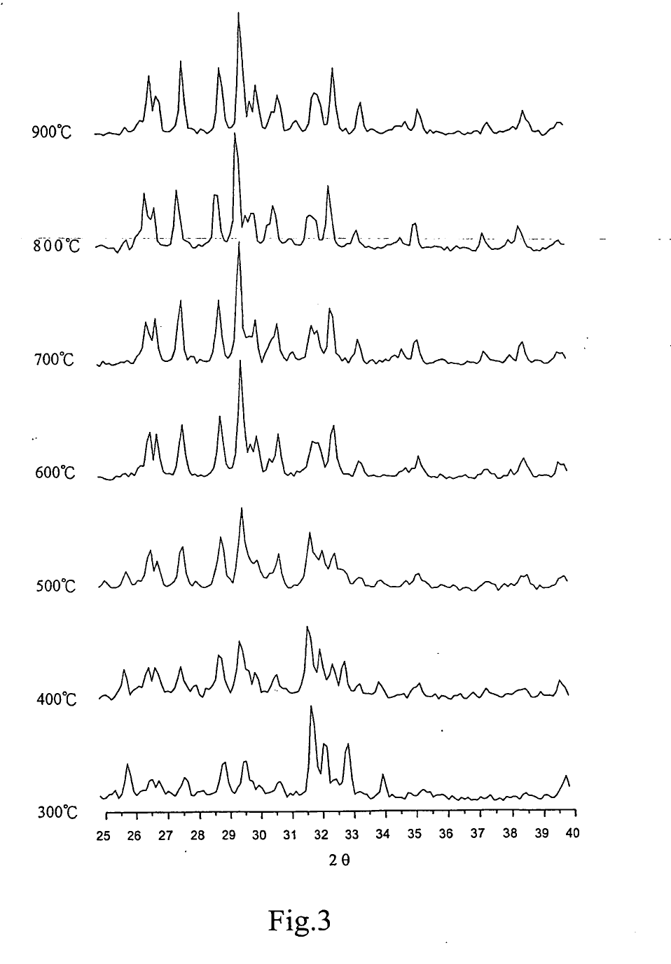

The same procedures as in example 1 are repeated, but this time the temperature of the SiC heating body is changed, instead, 6 temperatures are experimented with, wherein each respectively is set at 300, 400, 500, 600, 700, and 800° C. The results of crystalline phase changes determined by XRD analysis are as shown in FIG. 3.

From FIG. 3 it is discovered that the ox bone that is immersed in an AP aqueous solution at a temperature of 300° C. exhibits diffractions peaks. The intensity of the peak increases with the temperature. At a temperature of 600° C., almost all of the HAP of the ox bone are replaced by DCP. From the point where increases in temperature would not bring any phase changes, the material achieves a stable DCP crystalline phase. The ox bone immersed with AP aqueous solution under high temperature can be transformed to DCP crystalline phase at 600° C. Regardless whether TCP or DCP ceramic material shave sintering temperatures all above 600° C., therefore the present material can proceed with phase transition prior to sintering. It is not applicable if phase transition is taking place at the same time as sintering, because extreme phase transition during sintering may reduce the mechanical properties of the material. With the technique of the present invention, hydroxyapetite of the ox bone can be transformed into TCP or DCP, and in the near future biomedical material or raw material of osteoporosis medicine will have great application values.

From the examples of the present invention it is apparent that the method for preparing the present invention is not only able to produce porous bioceramic bone substitute material but is also able to control the types of crystalline phases and composition ratio of porous bioceramic bone substitute material through immersion under phosphate and control of sintering temperature.

Although the present invention has been explained in relation to its preferred embodiment, it is to be understood that many other possible modifications and variations can be made without departing from the scope of the invention as hereinafter claimed.

1. A method of preparing porous bioceramic bone substitute materials comprising:
(a) a cancellous bone of an animal;
(b) heating said cancellous bone for removing organic substances from said cancellous bone;
(c) immersing said organic free cancellous bone in a phosphate salt solution; and
(d) removing said organic free cancellous bone from said solution and drying said cancellous bone, sintering said cancellous bone at a temperature of 600˜900° C., and obtaining a porous bioceramic bone substitute material.

2. The method of claim 1, wherein said animal cancellous bone of step (a) is an ox cancellous bone.

3. The method of claim 1, wherein said cancellous bone of step (a) is dissected into parts dimensioned 0.1-10 cubic centimeters.

4. The method of claim 1, wherein said heating process of step (b) comprising boiling the cancellous bone in water for removing greases and fats from said cancellous bone, drying the bones afterwards, then heating the bones at 600° C.-800° C. for removing the organic substances of cancellous bones.

5. The method of claim 1, wherein said phosphate salt solution of step (c) is ammonium phosphate aqueous solution, alkaline metal phosphate aqueous solution or alkaline earth metal phosphate solution.

6. The method of claim 1, wherein said phosphate salt solution of step (c) is ammonium phosphate aqueous solution.

7. The method of claim 1, wherein said phosphate aqueous solution of step (c) is ammonium phosphate solution with a concentration greater than 1.0 mole/L.

8. The method of claim 1, wherein said porous bioceramic bone substitutes material of step (d) are β-TCP/DCP bi-phrase porous ceramic material and DCP single-phrase porous ceramic material.

9. The method of claim 1, wherein said porous bioceramic bones substitute material of step (d) is β-TCP/DCP bi-phase porous ceramic material.

10. The method of claim 1, wherein said porous bioceramic bones substitute material of step (d) is DCP single-phase porous ceramic material.
